(19) United States
(12) Patent Application Publication
(10) Pub. No.: US 2003/0213790 A1
(43) Pub. Date: Nov. 20, 2003

(54) Small electric oven

(76) Inventor: Chi Cheong Hui, Hong Kong (CN)

Correspondence Address: JACKSON WALKER L.L.P., Suite 2100, 112 E. Pecan Street, San Antonio, TX, 78205, US

(21) Appl. No.: 10/420,198

(22) Filed: Apr. 22, 2003

Related U.S. Application Data
(63) Continuation-in-part of application No. 09/872,521, filed on Jun. 1, 2001, now abandoned.

(51) Int. Cl. F27D 11/00

(52) U.S. Cl. 219/385; 219/391

(57) ABSTRACT

A small electric oven includes a base unit and a lid unit hinged to close over the base unit. A lower heat transmissive cooking platen is supported by the base unit and arranged such that any liquid on the platen drains in use towards one end of the platen. An upper heat transmissive cooking platen is supported inside the lid and fits over the lower cooking platen to define a heat transmissive cooking chamber that completely encloses a food item without direct contact with an upper portion of the food item. Electric heating elements are provided for each of the platens.

This application is a continuation-in-part of co-pending application Ser. No. 09/872,521, filed Jun. 1, 2001.

### BACKGROUND OF THE INVENTION

1. Field of the Invention

The invention relates to small electric ovens.

2. Description of Prior Art

So-called “small” ovens are portable and designed to rest on a work surface in use and be put away in a kitchen storage cupboard, say, when not in use. Nevertheless such ovens are capable of cooking joints of beef, a medium sized chicken and similar items, as well as baking cakes and pies, and toasting sandwiches.

In order to make these ovens portable they are usually constructed of light weight folded metal sheet. Upper and lower heating elements are disposed at the top and bottom of a cooking chamber. A problem is that the oven suffers from poor heat intensity and distribution because the folded metal cooking chamber results in loss of heat through outwards radiation.

### SUMMARY OF THE INVENTION

It is an object of the invention to overcome or at least reduce these problems.

According to the invention there is provided a small electric oven including a base unit, a lid unit hinged to the base unit, a lower heat transmissive cooking platen supported by the base unit and arranged such that any liquid on the platen drains in use towards one end of the platen, an upper heat transmissive cooking platen supported inside the lid and that fits over the lower cooking platen, the upper and lower platens defining a heat transmissive cooking chamber that completely encloses a food item without direct contact with an upper portion of the food item, and electric heating elements for each of the platens.

The first cooking platen may have a corrugated surface interspaced with grooves extending towards the one end and the grooves sloping down towards the one.

The first platen preferably may have an aperture adjacent said one end through which liquid can pass into a collecting tray.

The collecting tray may be slidingly mounted in the base unit and removable therefrom.

A separate thermostat may be provided for each platen.

### BRIEF DESCRIPTION OF THE DRAWINGS

Small electric ovens according to the invention will now be described by way of example with reference to the accompanying drawings in which:

FIG. 1 is an isometric exterior view of the oven;

FIG. 2 is a sectional side view of the oven with a fixed bottom platen;

FIG. 3 is exploded view of an oven similar to the oven of FIG. 2 with a removable bottom platen, and

FIG. 4 is a sectional side view of a similar oven with a different form of bottom platen.

### DESCRIPTION OF THE PREFERRED EMBODIMENT

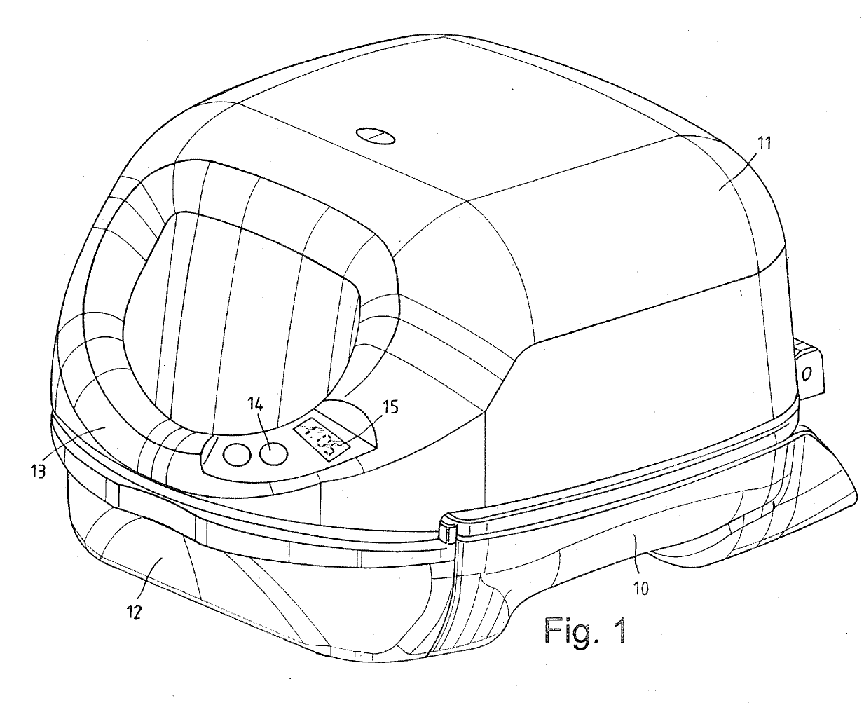

Referring to the drawings, in FIG. 1 the oven has a base unit 10 and a lid unit 11 that is hinged to the base unit and arranged to close over the base unit. A collection tray 12 slidingly fits into the base unit 10 and a lifting handle 13 is integrally molded with the lid unit. Control buttons 14 and a digital timer 15 are carried in the handle 13.

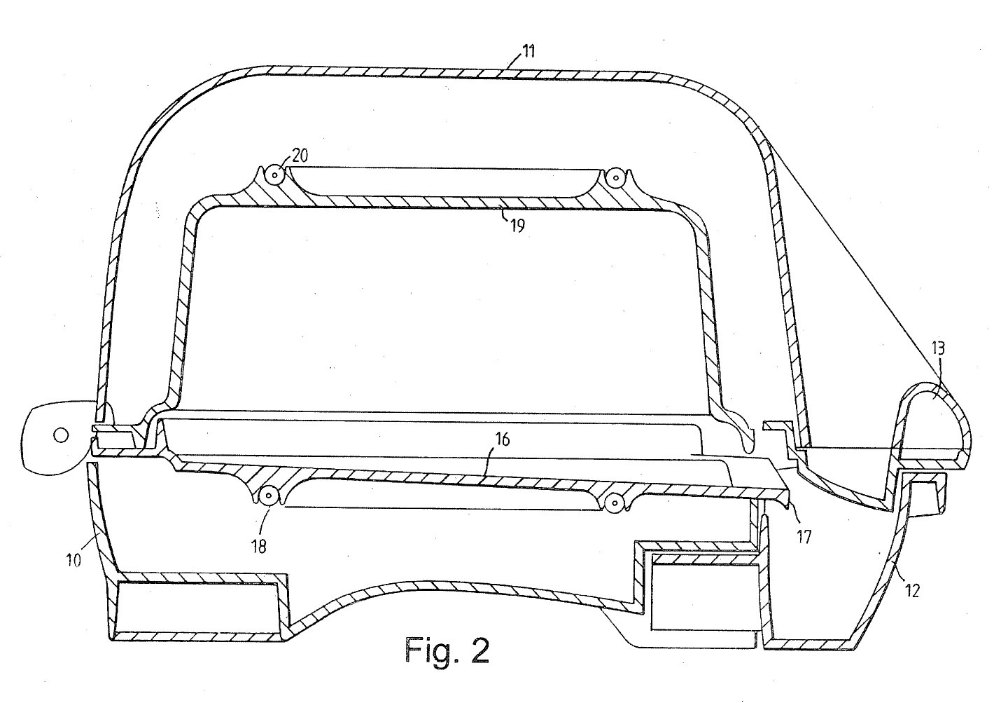

In FIG. 2, a fixed corrugated bottom platen 16 is mounted so that grooves of the corrugation slope down towards one end of the platen, where a pouring lip 17 is integrally formed above an open top of the collection tray 12. An electrical heating element 18 is mounted in intimate physical contact with the platen 16.

A top platen 19 is mounted in the lid unit 11 and has a heating element 20. The platen 19 has a planar top 19 and side walls 25. When the lid unit 11 is closed over the base unit 10 the top and bottom platens define a cooking chamber that completely encloses a food item to be cooked. The top cooking platen does not directly contact an upper portion of the food item.

The top and bottom cooking platens are made of a heat transmissive material so that substantially all of the platen is evenly heated by the heating element. Heat is radiated into the cooking chamber from all internal surfaces of the platen providing intense and uniform heat distribution within the cooking chamber.

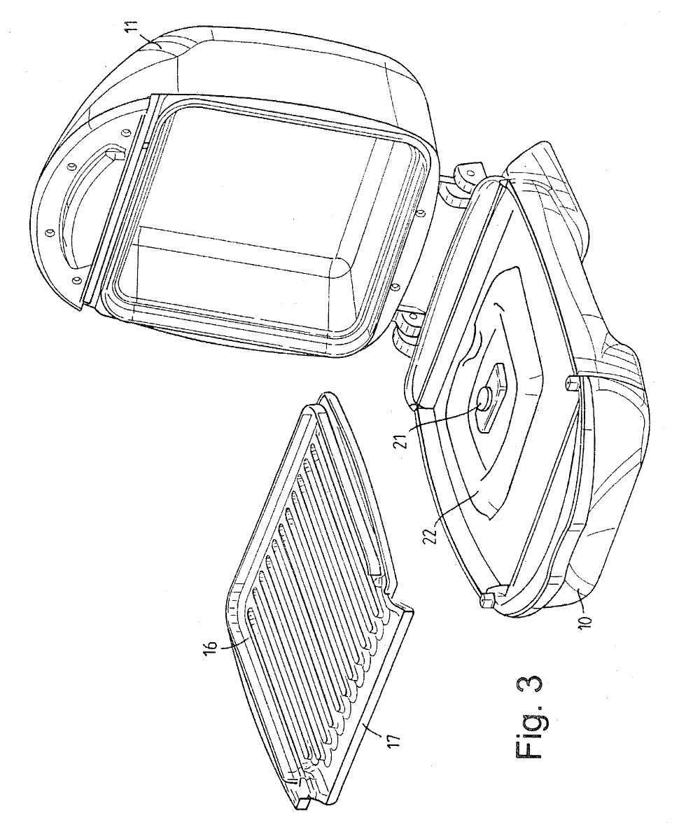

In FIG. 3, the oven has removable platen 16 (having the same configuration as the platen 16 in FIG. 2). Exposed in the base unit is a thermostat 21 and an enclosed electric heating element 22 is provided. The platen base is formed with a “foot print” that fits over the enclosed element as described in U.S. Pat. No. 6,429,409.

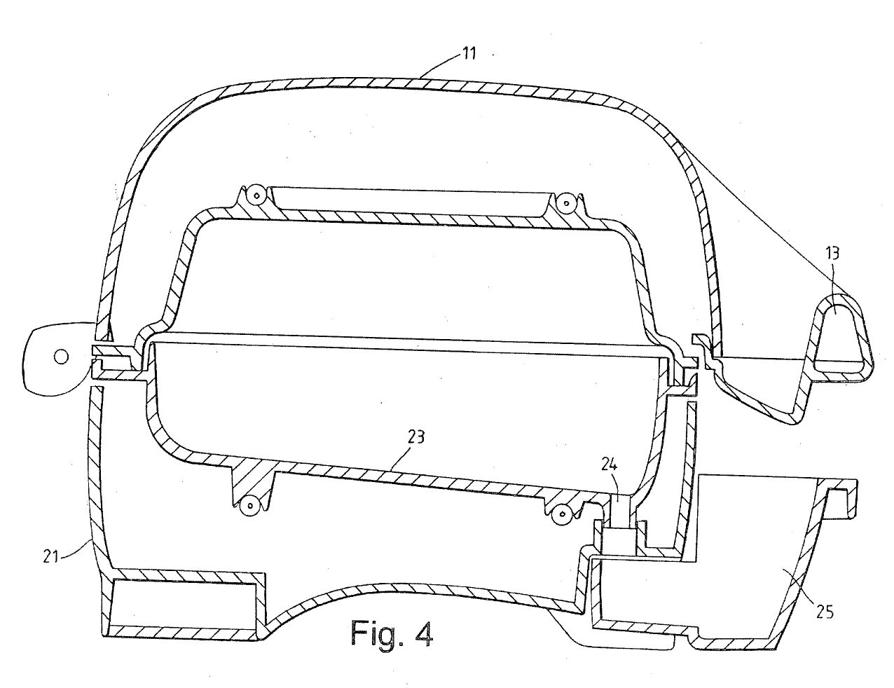

In FIG. 4, a base unit 23, having a planar base, is deeper than the platen units 16 in FIGS. 2 and 3. The base unit 23 is mounted with its base sloping towards one end. Adjacent the one end of the platen an aperture 24 is formed to allow fluids to drain into a collection tray 23. In an alternative arrangement, the platen 23 can be mounted with its base horizontal and formed with corrugations. In that case, bottoms of the grooves formed by the corrugations slope down towards the one end, in same manner as the grooves in the platen 16. Fat therefore drains towards the aperture 24 during use. It is well known in the art to have a manually settable control unit for a small oven, that can turn electric power ON and OFF automatically as required, and to respond to operations of thermostats, such as thermostat 21, placed in the oven. Such components and control functions are therefore not described in detail and not all shown in the Figures.

Embodiments of the invention however provide ovens with either a sloping planar based platen, or a platen with sloping grooves in a corrugated array. (The platen may also be removable as shown in FIG. 3 for ease of cleaning.) The sloping of the platen or the sloping grooves ensures that liquids, including hot fat, drain away from foodstuff during cooking for collection in the trays 12 or 25 during use of the oven. The collected liquid or solidified fat can be readily removed by sliding out the trays 12 or 25 after cooking is completed, and the trays emptied and cleaning out. Because the moisture and fat is continually drained away, the cooking conditions are much improved. Further, the fat or other juices released during cooking are less prone stain or to “burn” onto the surfaces of the platen and so the platen remains serviceable longer and is easier to keep clean.

I Claim:

1. A small electric oven including:
a base unit
a lid unit hinged to the base unit,
a lower heat transmissive cooking platen supported by the base unit and arranged such that any liquid on the platen drains in use towards one end of the platen,
an upper heat transmissive cooking platen supported inside the lid and that fits over the lower cooking platen, the upper and lower platens defining a heat transmissive cooking chamber that completely encloses a food item without direct contact with an upper portion of the food item, and
electric heating elements for each of the platens.

2. A small electric oven according to claim 1, in which the first cooking platen has a corrugated surface interspaced with grooves extending towards the one end and the grooves sloping down towards the one end.

3. A small electric oven according to claim 1, in which the first platen has an aperture adjacent said one end through which liquid can pass into a collecting tray.

4. A small electric oven according to claim 3, in which the collecting tray is slidingly mounted in the base unit and removable therefrom.

5. A small electric oven according to claim 1, including a separate thermostat for each platen.
